(19) United States
(12) Patent Application Publication
(10) Pub. No.: US 2016/0147943 A1
(43) Pub. Date: May 26, 2016

(54) Semantic Address Parsing Using a Graphical Discriminative Probabilistic Model

(71) Applicant: Argo Data Resource Corporation, Richardson, TX (US)

(72) Inventors: Stephen M. Ash, Memphis, TN (US); William M. Siler, Cordova, TN (US)

(21) Appl. No.: 14/550,005

(22) Filed: Nov. 21, 2014

(51) Int. Cl. G06F 19/00; G06N 7/00; G06F 17/27

(52) U.S. Cl. CPC G06F 19/322; G06F 17/271; G06N 7/005

(57) ABSTRACT

A system for managing medical records based on semantic address parsing. The system comprises a processor, a memory, and an application that comprises a semantic address parser that incorporates a graphical discriminative probabilistic model. When executed by the processor the application receives an address as input comprising tokens and for each token identifies a feature value of at least one feature associated with the token. The application analyzes the feature values to determine an address label for each token and based on the address labels of the tokens, converts the input patient address to a canonical address format. The application searches a data store of medical records to find a stored medical record having a patient address that matches the input address in canonical address format and processes a medical record associated with the input patient address based on the matching stored medical record.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Machine learning is a complex discipline that creates and uses computer executed algorithms that learn from data. Algorithms based on machine learning may be used in computational tasks for which developing explicit and fully articulated solutions are an intractable problem. A wide variety of applications are thought to be amenable to machine learning approaches, including machine perception, computer vision, natural language processing, search engines, speech recognition, robot locomotion, and others.

A machine learning algorithm processes new data based on properties of the data universe the algorithm has learned from previously processing training data selected from the same data universe. Here the informal term “data universe” merely suggests that the data that the learning algorithm processes may have some characteristics that distinguish it from just any data—for example a data universe may comprise image data formatted in a specific graphical image format, a data universe may comprise a sequence of speech phonemes. Supervised machine learning involves presenting input data along with the desired or correct results of the algorithm processing the input data. By comparing the errors between the actual processing results produced by the algorithm to the desired or correct results, the algorithm can learn by adapting internal parameters of the algorithm. The input data that is provided to the algorithm during its learning or training phase may be referred to as training data.

### SUMMARY

In an embodiment, a computer system for managing medical records based on semantic address parsing is disclosed. The system comprises a processor, a memory, an application that comprises a semantic address parser that incorporates a graphical discriminative probabilistic model and that is stored in the memory. When executed by the processor, the application receives a patient address as input, wherein each separate word in the patient address is a token and for each token identifies a feature value of at least one feature associated with the token, wherein a feature is a determinable pre-defined property of the tokens and wherein at least one of the tokens is associated with two or more features. The application further analyzes the feature values of the features associated with the tokens to determine an address label for each token, wherein the address labels indicate a semantic meaning of the tokens and, based on the address labels of the tokens, converts the input patient address to an input address in canonical address format. The application further searches a data store of medical records to find a stored medical record having a patient address that matches the input address in canonical address format and processes a medical record associated with the input patient address based on the matching stored medical record.

In an embodiment, a method of training a semantic address parsing learning machine having a graphical discriminative probabilistic model is disclosed. The method comprises parsing a plurality of training addresses into tokens, wherein the parsing is performed by a computer and parsing each token of the training addresses into values of features by the computer, wherein a feature is a determinable pre-defined property of the tokens, wherein the features comprise at least two of a line boundary feature, a before city/after city feature, a before number/after number feature, and a tag object pair feature, wherein at least some of the tokens are associated with two or more features. The method further comprises, based on the values of features of the tokens and based on a conditional probability distribution of label assignment configured in the graphical discriminative probabilistic model, determining an address label for each token by the computer, wherein the address label indicates a semantic meaning of the token and determining an error of the address labels determined for the tokens of the training addresses by the computer based on a pre-defined correct association of address labels for each token. The method further comprises, based on the error of the address labels, adapting the conditional probability distribution of label assignment configured in the graphical discriminative probabilistic model using a quasi-Newton optimization algorithm executed by the computer, whereby the graphical discriminative probabilistic model of the semantic address parsing learning machine is trained to more accurately associate address labels with tokens.

In an embodiment, a method of managing medical records using a semantic address parsing learning machine having a graphical discriminative probabilistic model is disclosed. The method comprises receiving by a computer an input address, wherein each separate word in the input address is a token, identifying by the computer a feature value of at least one feature associated with each token in the input address, wherein at least one of the tokens in the input address is associated with at least two features, wherein a feature is a determinable pre-defined property of the tokens, and analyzing by the computer the feature values of the tokens based on a conditional probability distribution of label assignment configured in the graphical discriminative probabilistic model. The method further comprises, based on analyzing the feature values of the tokens, determining by the computer an address label for each of the tokens of the input address and, based on the address labels associated with the input address, converting the input address to an input address in a canonical address format by the computer. The method further comprises searching a data store of medical records to find a stored medical record having a patient address that matches the input address in canonical address format and taking action by the computer based on the match, wherein the action is one of avoiding performing a healthcare procedure on a patient based on the stored medical record that matches the input address in canonical address format, identifying a medication allergy reported in the stored medical record that matches the input address in canonical address format, and consolidating a medical history of a patient.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a semantic address parsing computer system according to an embodiment of the disclosure.

FIG. 2 is a flow chart of a method of training a semantic address parsing learning machine according to an embodiment of the disclosure.

FIG. 3 is a block diagram of another semantic address parsing computer system according to an embodiment of the disclosure.

FIG. 4 is a flow chart of a method according to an embodiment of the disclosure.

FIG. 5 is a flow chart of another method according to an embodiment of the disclosure.

FIG. 6 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Addresses entered into computer systems by human beings (e.g., by a hospital emergency room admissions clerk) are associated with substantial variability. For example, the semantically same address may be represented in a number of syntactically different ways: (1) 123 West Main Street, Anycity, Anystate 12345-6789; (2) 123 W Main Street, Anycity, Anystate 12345-6789; (3) 123 West Main St, Anycity, Anystate 12345-6789; (4) 123 W Main, Anycity, Anystate 12345-6789; (5) 123 Main, Anycity, Anystate 12345-6789; (6) 123 West Main Street, Anycity, Anystate 12345. A human reader would generally easily recognize these syntactically different addresses to refer to the same semantic address. Examples of other syntactical variations of the semantically common address could have been provided. When trivial keying errors are considered—double keyed letters, transposed letters, misspellings—the number of syntactical variations of the semantically common address grows further.

Human beings are generally adept at sorting out the semantic address from a large number of syntactical variations of the address. Computer based address handling systems, however, can be severely challenged by syntactical variations in addresses. Said in another way, computer based address handling systems may fail to match syntactically different addresses that in fact relate to the same semantic address. In many situations addresses must be processed by automated computer processes. For example, a human being cannot hope to match an address of a patient seeking treatment at an emergency room, in real-time, with a semantically identical but syntactically different address contained in one or more medical records stored in an electronic data store comprising tens of thousands or hundreds of thousands of medical records. This is a task that can only be accomplished by an automated computer process.

The present disclosure teaches a semantic address parser executing on a computer that uses a graphical discriminative probabilistic model. This semantic address parser associates an address label to each word or token of the input address. As used herein, an address label is a name for the role an address token plays in an address. Conventionally, the term address label may call to mind a physical piece of paper or other fabric printed with an address on one side that may have an adhesive on the side opposite the printing. Here, the address label is an abstraction that may be said to identify the semantic meaning of an address token. Some examples of address labels, as the term is used herein, are a pre-direction address label, a street name address label, a designator address label, a post-direction address label, a city name address label, a state name address label.

An address typically comprises a plurality of address tokens that may be associated with a plurality of different address labels. For example, the semantic address parser may parse the address 123 W Main St, Anycity, Anystate, 12345 as follows. The “123” token is associated with or deemed a street number address label; the “W” token is associated with or deemed a street pre-directional address label; the “Main” token is associated with or deemed a street name address label; the “St” token is associated with or deemed a street designator address label, the “Anycity” token is associated with or deemed a city name address label; the “Anystate” token is associated with or deemed a state name address label; and the “12345” token is associated with or deemed a 5 digit zip-code address label. In some contexts herein address labels may be referred to more succinctly as labels.

This semantic address parser may be said to constitute an improved computer system and/or an improved semantic address parser. It is thought that the disclosed semantic address parser provides significantly improved parsing of input addresses. The disclosure teaches the use of the semantic address parser in a medical records processing use case, but it is understood that the semantic address parser may be applied advantageously to other applications.

Once the input address is parsed into tokens and the tokens are labeled, the input address tokens can be transformed into a canonical address format. For example, the “W” token may be transformed into “West.” The “St” token may be transformed into “Street.” By transforming the input address tokens into canonical formats based on the address label associated with the tokens, comparison of the input address to other addresses stored in canonical address format in a records data store (e.g., medical records stored in a patient medical records data store of a hospital or of a centralized medical records data store) can be performed to identify matches. For example, the address input by an emergency room admission clerk may be determined to match an address of a patient medical record stored in a hospital data store, the matching stored patient medical record may indicate to the clerk that the subject patient is allergic to medication X, and the medical staff of the emergency room may be alerted to avoid administering medication X to the patient, even when the patient may have been unconscious and unable to answer questions about allergies to medications.

The semantic address parser may operate in two modes: in a learning mode and in a working mode. In some contexts, the semantic address parser may be referred to as a semantic address parser learning machine. Alternatively, the semantic address parser may be said to exist in two different states: in a learning state or a development state and in a production state or a deployed state. In the learning mode or learning state, technicians or engineers feed training data into the semantic address parser to facilitate the semantic address parser's learning.

The semantic address parser “learns” by parsing training address input to associate address labels to address tokens based on an interim conditional probability distribution, comparing the determined address labels to the human adjudicated address labels for each address token to determine an error (the human adjudicated address labels associated with address tokens is also a training input), and adapting the interim conditional probability distribution based on the error. More specifically, the weights or coefficients of features and combinations of features in the conditional probability distribution are adapted. In an embodiment, the interim conditional probability distribution relates to the conditional probabilities of an address label given the address tokens and given the previously determined address label, i.e., P(label_y|token[0 . . . x], label_y−1). By repeating this training cycle, the weights or coefficients of features in the conditional probability distribution can be improved or optimized to reduce the error. In some contexts, adapting the weights and/or coefficients of features and combinations of features may be referred to as adapting the conditional probability distribution.

The semantic address parser is implemented as software or as a computer program. The portion of the semantic parser that executes during training (for example, the portion that determines error and adapts the weights of features in the conditional probability distribution) may not be active (e.g., may be disabled) when the semantic address parser is in the production state or deployed state. Alternatively, the semantic address parser program may be built for deployment without the software component or components that are responsible for determining error and adapting the weights of features of the conditional probability distribution. The building of the semantic address parser for deployment may incorporate the final or production version conditional probability distribution (e.g., the last value of the conditional probability distribution and/or the weights of the features of the conditional probability distribution determined during the training cycle) and the components that determine address labels to associate with address tokens based on the conditional probability distribution.

In the production or deployed mode of operation, the semantic address parser may first discard some punctuation marks, for example commas and periods from an input address. The semantic address parser then parses an input address into a sequence of words or tokens. A word may be any string of alphanumeric characters that is set off by spaces. The semantic address parser takes note of any line breaks in the input address and then creates an address token sequence without line breaks. The semantic address parser may take note of a line break by associating the line break with the token following the line break. Alternatively, the semantic address parser may associate the line break with the token preceding the line break.

The semantic address parser then analyzes each token based on a plurality of address features to assign feature values to the address features that apply to each token. It is understood that two or more address features may associate to or apply to a single address token. It is also understood that determining the features of a token may comprise analyzing both tokens that precede the subject token and tokens that follow the subject token. Said in another way, the features of a token may be determined in part based on the values of the features of tokens that are proximate to the subject token. Also, determining the features of a token may be determined in part based on the address label assigned to an address token preceding the subject token. As understood by one skilled in the art, the term “feature,” as used in the context of machine learning, refers to a determinable or measurable property of the item being observed. In the instant application, an address feature is a determinable property of an address token.

It is thought that at least some of the address features employed in the semantic address parser are novel and promote improved performance of semantic address parsing. These address features will be described more fully hereinafter, but a brief description is provided here to provide a base of understanding. Some example address features are (1) a number or letter feature, (2) a bucketed word length feature, (3) a before number/after number feature, (4) a neighbor features feature.

In the address “123 West Main Street, Anycity, Anystate, 12345,” the token “123” has the value ‘number’ with reference to the number or letter feature. The token “123” has the value ‘3’ with reference to the bucketed word length feature. With reference to the neighbor feature, the token “123” has the value of the features of the token “West” where those feature values are designated as associated with the token immediately following (e.g., a ‘+1’ designator or note is appended to the literal values of those features) and the value of the features of the token “Main” where those feature values are designated as associated with the second following token (e.g., a ‘+2’ designator or note is appended to the literal values of those features). The token “123” has no value for the before number/after number feature or may be said to have a null value of this feature. The token “West” has the value of ‘letter’ with reference to the number or letter feature, has a the value of ‘4’ with reference to the bucketed word length feature, has the value of ‘after number’ with reference to the before number/after number feature. With reference to the neighbor feature, the token “West” has the value of the features of token “123” where those feature values are designated as associated with the token immediately preceding (e.g., a “−1’ designator or note is appended to the literal values of those features), the values of the features of token “Main” where these feature values are designated as associated with the token immediately following (e.g., a ‘+1’ designation or note is appended to the literal values of those features), and the values of the features of token “Street” where these feature values are designated as associated with the second following token (e.g., a ‘+2’ designator or note is appended to the literal values of those features).

After determining feature values for the address tokens, the semantic address parser assigns address labels to address tokens based on the feature values and based on the conditional probability distribution. Said in other words, after determining feature values, the semantic address parser no longer operates upon or processes the address token itself but instead operates upon or processes the feature values associated with the address token. The conditional probability distribution defines probabilities of address labels conditioned on feature values of address token and the address label assigned to the preceding address token. The semantic address parser performs a calculation based on the feature values of an address token and the conditional probability distribution to determine what the probability is that the subject address token is each of the possible address labels (the different address labels is a relatively short list of labels) and assigns the address label to the subject address token that is associated with the highest probability. In an embodiment, the assignment of address labels to tokens by the semantic address parser is based on maximizing the probability of labels across the entire sequence of address tokens of an address.

The probability model that is taught herein is a discriminative probability model. This is different from a generative probability model. An example of a generative probability model is a hidden Markov model (HMM). It is thought that in some applications, for example classification tasks generally and semantic address parsing specifically, discriminative probability models can outperform generative probability models because the discriminative probability model can model conditional probability distributions directly instead of modeling latent or hidden variables using incomplete or naïve assumptions about the hidden process (as the generative probability models must do). Said in other words, the generative probability modeling approach attempts to learn a joint probability distribution, i.e., P(X, Y), (a more general and hence more difficult problem to solve) while the discriminative probability modeling approach attempts to learn a conditional probability distribution, i.e., P(Y|X). In a preferred embodiment, the semantic address parsing applies a conditional random fields (CRF) discriminative probability model.

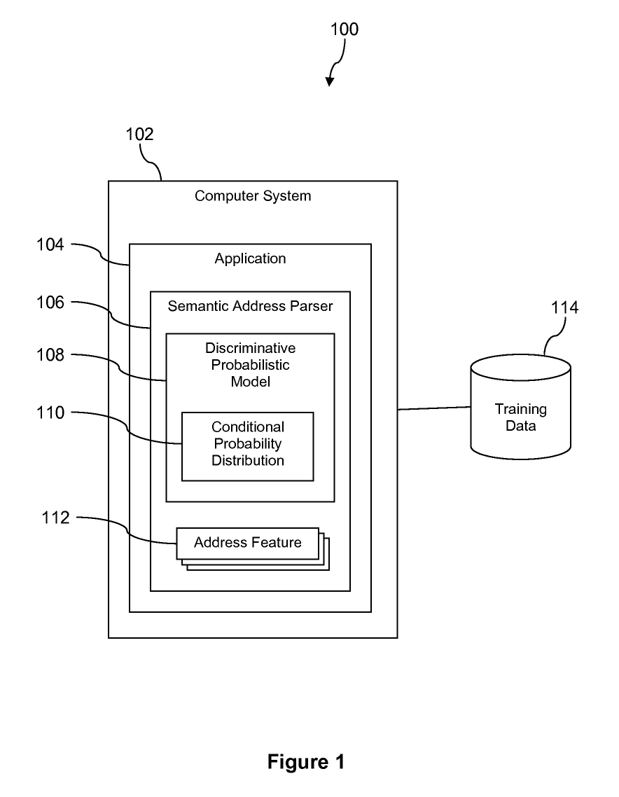

Turning now to FIG. 1, a system 100 is described. In an embodiment, system 100 comprises a computer system 102 that comprises an application 104. The application 104 comprises a semantic address parser 106 that comprises a discriminative probabilistic model 108 and a plurality of address features 112. The discriminative probabilistic model 108 may encapsulate a conditional probability distribution 110. The discriminative probabilistic model 108 is a graphical probabilistic model. The application 104, the semantic address parser 106, the discriminative probabilistic model 108, the conditional probability distribution 110, and the address features 112 may be stored in a memory of the computer system 102.

It is understood that the components 106, 108, 110, 112 may be drawn or represented in other ways, for example nested differently or all drawn or represented as independent boxes within the application 104. The application 104, the semantic address parser 106, and the discriminative probabilistic model 108 may be implemented as software, as firmware, or as other machine logic that is executed by one or more processors of the computer system 102. Additionally, the application 104, the semantic address parser 106, or the discriminative probabilistic model 108 may comprise a plurality of components not shown here. For example, the semantic address parser 106 may comprise a training component that is distinct from a production component. In an embodiment, after training of the discriminative probabilistic model 108 and or the conditional probability distribution 110 has been completed, a production version of the semantic address parser 106 may be built that does not include the training component. Alternatively, software components in the semantic address parser 106 and/or the discriminative probabilistic model 108 used in training may be disabled in a production version of the semantic address parser 106. Computer systems are described further hereinafter.

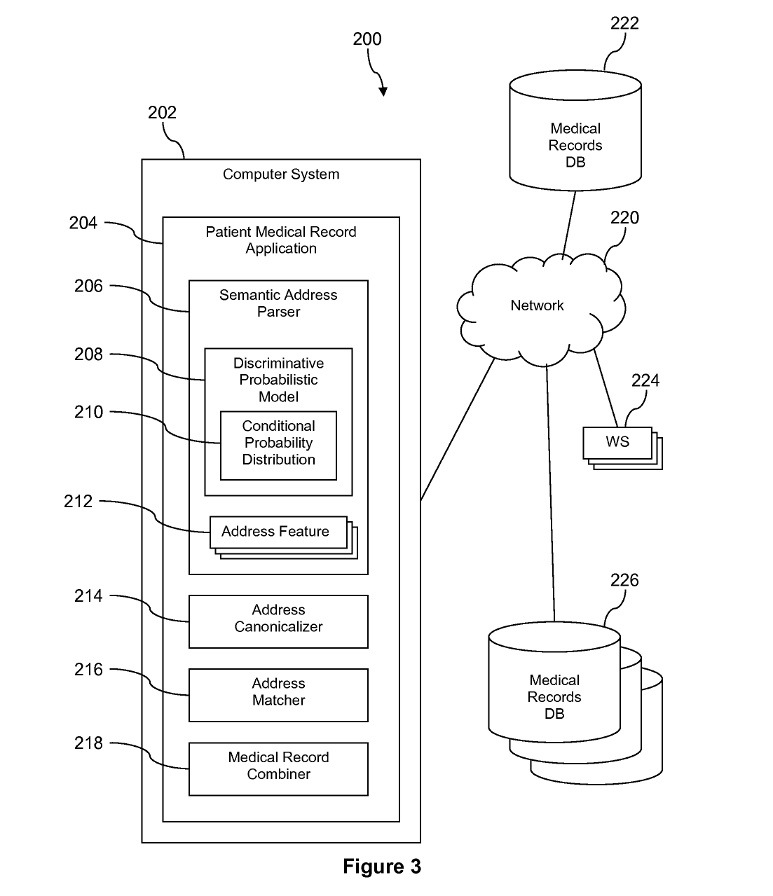

The system 100 may further comprise a data store 114 of training data. The training data may comprise both training addresses and human adjudicated address labels corresponding to address tokens of the training addresses. In some contexts, the human adjudicated address labels may be referred to as “correct results.” The training addresses may be selected to challenge and stress the semantic address parser 106. A number of syntactically different training addresses may associate to the same semantic address and to the same human adjudicated address labels. For example, a single address in canonical format may be transformed to a plurality of related but syntactically different addresses, whereby to cause the semantic address parser 106 to learn desirably. For example, some parts of addresses may be suppressed to stress the semantic address parser 106 and drive learning, for example suppressing a token that is a designator label or a token that is a pre-direction label. It is hoped that this kind of training data can make the trained semantic address parser 106 more robust to real-world address data. It is understood that the data store 114 may not be present in a deployed version of the computer system 102, for example as illustrated in FIG. 3.

As described above, the semantic address parser 106 may first remove punctuation marks such as commas and periods from the training or input addresses. The parser 106 may then parse the training or input address into a sequence of words or tokens. The parser 106 then determines feature values for each of the tokens in the subject training or input address. The parser 106 then determines address labels for each token based on the feature values associated with the tokens, based on the discriminative probabilistic model 108, and based on the conditional probability distribution 110. The conditional probability distribution 110 identifies probabilities of address labels conditioned on feature values. Said in another way, the conditional probability distribution 110 defines weights of features for use in the discriminative probabilistic model 108.

In an embodiment, address labels comprise a recipient label, a care of tag label, a care of object label, a PO box tag label, a PO box object label, a street number label, a pre-direction label, a street name label, a designator label, a post-direction label, a rural route tag label, a rural route object label, a rural route box tag label, a rural route box object label, a highway tag label, a highway object label, a city name label, a state name label, a five digit zip-code label, a four digit zip-code label, a nine digit zip-code label (e.g., when a five number zip-code is concatenated with a four number zip-code without a separating hyphen), a country name label. In the exemplary address “123 West Main Street,” “West” is a pre-direction label and “Street” is a designator label. In the exemplary address “1234 I-35 East”, “East” is a post-direction label (there is an I-35 East and an I-35 West in the Dallas-Fort Worth, Tex. metroplex area). It is understood that in different embodiments fewer address labels may be employed and in other embodiments additional address labels may be employed. Because different countries and different languages may use different addressing structures and different addressing literals, it is contemplated that different address labels may be defined for the address parser in different countries. In an embodiment, a simple address label list may comprise only a recipient label and a not-a-recipient label.

In some addresses, two or more tokens may be associated with the same address label. For example, the address fragment “123 West Rock Hill Road” may be parsed where “123” is a street number label, “West” is a pre-direction label, “Rock” is a street name label, “Hill” is also a street name label, and “Road” is a designator label. In another embodiment, however additional address label values may be employed.

Features in the context of machine learning refer to determinable properties or characteristics of something being observed. In the instant application, address features refer to determinable properties or characteristics of address tokens (e.g., the address tokens are the things being observed). Defining features for learning machines and/or graphical probability models is a creative activity that may be referred to as feature engineering. Well engineered features can make a given learning machine and/or graphical probability model effective, and poorly engineered features can make the same learning machine and/or graphical probability model ineffective or inaccurate. It is thought that the address features described herein may be novel and may contribute to the effectiveness and accuracy of the semantic address parser 106 and/or discriminative probabilistic model 108. A number of different address features are described below. In an embodiment, some or all of these features may be used as the address features 112 by the semantic address parser 106 and the discriminative probabilistic model 108. Alternatively, in another embodiment, some of the described address features may not be used and/or additional address features may be used by the semantic address parser 106 and the discriminative probabilistic model 108.

A “number or letter” feature may be a first address feature. Address tokens may be characterized relative to the number or letter feature as being a number or a letter. In an embodiment, an address token may be characterized relative to the number or letter feature as being neither or as being null, for example when the subject address token does not clearly satisfy the criteria defined for being a number or being a letter (e.g., “14B” may not satisfy the criteria for being a number or being a letter because it is a hybrid or mix of both). In the example address “123 West Main Street, Anycity, Anystate, 12345-6789,” the token 123 can be characterized as being a number, and the token West can be characterized as being a letter in terms of the number or letter feature.

A “bucketed word length” feature may be a second address feature. Address tokens may be characterized relative to the bucketed word length feature as having a word length of 1, 2, 3, 4, 5, 6-8, 9-12, 13-17, and 17+. In the example address “123 West Main Street, Anycity, Anystate, 12345-6789,” the token 123 can be characterized as having a length of 3, and the token Anystate can be characterized as having a length of 6-8 with reference to the bucketed word length feature. It is understood that in different embodiments, different literal values may be used for characterizing address tokens with reference to the bucketed word length feature.

A “contains number” feature may be a third address feature. Address tokens may be characterized relative to the contains number feature as true or false. For example, an address token “14B” can be characterized as having a value of true with reference to the contains number feature. This feature can be used by the semantic address parser 106, the discriminative probabilistic model 108, and/or the conditional probability distribution 110 to help assign an address label more accurately.

A “basic dictionary tagging” feature may be a fourth address feature. The values associated with the basic dictionary tagging feature comprise a list of common token literals and corresponding address labels. This list comprises cardinal directions, common designators, ordinals (1^{st}, 2^{nd}, etc.), names of cities, names of states, and abbreviations. When it applies, the basic dictionary tagging feature provides a chance to jump directly to a highly likely assignment of an address label. On the other hand, the association of the token to label provided by the basic dictionary tagging feature is not certain and is still articulated in the conditional probability distribution 110 as a probability value less than 1.0. For example, the address token “ST” doesn't always semantically mean “street,” sometimes it is the first address token in the two token city name “ST Louis.” Other features associated with the subject address token may lead in a countervailing sense to the association to an address label indicated by the basic dictionary tagging feature.

A “before number/after number” feature may be a fifth address feature. Address tokens may be characterized as before a number, after a number, or null with reference to the before number/after number feature. In the example address “123 West Main Street, Anycity, Anystate, 12345-6789,” the token 123 can be characterized as being null with reference to the before number/after number feature, the token West can be characterized as being after a number with reference to the before number/after number feature, and the token Anystate can be characterized as being before a number with reference to the before number/after number feature. It is noted that the before number/after number feature inherently looks one address token ahead and one address token behind a given address token being characterized with reference to the before number/after number feature.

An “after care of” feature may be a sixth address feature. The values associated with the after care of feature are after care of and null. Given the example address, “John Smith care of Bill Brown 123 West Main Street, Anycity, Anystate 12345-6789,” the token Bill can be characterized as after care of with reference to the after care of feature.

A “before city/after city” feature may be a seventh address feature. The values associated with the before city/after city feature are before city, after city, and null. In the example address “123 West Main Street, Anycity, Anystate, 12345-6789,” the token 123 can be characterized as being null with reference to the before city/after city feature, the token Street can be characterized as being before city with reference to the before city/after city feature, and the token Anystate can be characterized as being after city with reference to the before city/after city feature. It may be the case that the characterization of an address token with reference to the before city/after city feature may be based on an address label of city name with an address token based on the basic dictionary tagging feature or based on some other determination of the address label of city name. It is noted that the before city/after city feature inherently looks one address token ahead and one address token behind a given address token being characterized with reference to the before city/after city feature.

A “multiple basic dictionary tags” feature may be an eighth address feature. The values of an address token may take multiple values from the basic dictionary tagging feature listed above. Some address tokens may match two or more basic dictionary tags. This feature may promote the discriminative probabilistic model 108 and/or the conditional probability distribution 110 deciding which of two competing address labels to apply.

A “near and” feature may be a ninth address feature. Address tokens may be characterized as near and or not near and with reference to the near and feature. This address feature may not apply to many addresses, but when it does apply it may be very useful for assigning the address label appropriately, for example assigning the address label recipient to the address token.

A “neighbor features” feature may be a tenth address feature. An address token may be characterized with reference to the neighbor features feature by assigning all the feature values associated with the address token that precedes the subject address token and all the feature values associated with the two address tokens that follow the subject address token. The values of the neighbor features have a note or information appended to the literal value to indicate the position of the subject neighbor token relative to the token for example a ‘−1’ appended to indicate the token preceding, a ‘+1’ appended to indicate the token immediately following, and a ‘+2’ appended to indicate the second following token. It is noted that the neighbor features feature inherently looks one address token in front of and two address tokens behind the given address token being characterized with reference to the neighbor features feature. This may have the effect of enriching the analysis process of assigning an address label to an address token based on information of the context of the address token—information about the address tokens that are neighbors to the subject address token.

A “tag object pair” feature may be an eleventh address feature. An address token may be characterized as a tag object pair or as null with reference to the tag object pair feature. The value of tag object pair may be assigned to a first token and a second token when the first token is a known (pre-defined or listed in a dictionary) label and the following second token is a number. This can help keep the semantic address parser 106 from splitting up adjacent address tokens that ought to be analyzed together.

A “line boundary” feature may be a twelfth address feature. An address token may be characterized as following a line boundary with reference to the line boundary feature when a line break preceded the subject address token.

It is understood that the address features 112 may comprise all of the twelve address features described in detail above, a selection of the twelve address features, and/or additional address features. In an embodiment, the address features described in detail above may be modified in small or in trivial ways. For example, the bucketed word length feature may have a different number of literal values associated with it and may have different groupings of word length values. The neighbor features feature may have features of more than one preceding token. The neighbor features feature may have features of only one following token or of more than two following tokens.

In an embodiment, the discriminative probabilistic model 108 is a conditional random field (CRF) probabilistic model. Because the semantic address parser 106 and/or the discriminative probabilistic model 108 train based on correct answers or human adjudicated address labels, this training may be referred to as supervised machine learning or supervised training. When training the discriminative probabilistic model 108 and the conditional probability distribution 110, the semantic address parser 106 may calculate a gradient of the error of assignment of address labels to address tokens and use the gradient to adapt the conditional probability distribution 110 (i.e., to adapt the weights of features), where a gradient is a rate of change of the error with respect to multiple variables. In an embodiment, the conditional probability distribution 110 may be adapted based on the error gradient using a quasi-Newton optimization algorithm. In an embodiment, a limited-memory Broyden-Fletcher-Goldfarb-Shanno (LBFGS), which is an example of a quasi-Newton optimization algorithm may be used. Alternatively, another optimization algorithm may be used to adapt the conditional probability distribution 110.

In an embodiment, the majority of the training address data in the data store 114 may be used to train the semantic address parser 106, the discriminative probabilistic model 108, and/or the conditional probability distribution 110 and the remainder of the training address data may be used to test the effectiveness of the interim conditional probability distribution 110 that is arrived at during the subject training cycle. For example, 90% of the training data may be used for training the conditional probability distribution 110 and the remaining 10% may be used for testing the effectiveness of the interim conditional probability distribution 110. In the next cycle of training or learning, again 90% of the training data may be used for training and the remaining 10% of training data used for testing the effectiveness, but the distribution of the addresses in the data store 114 into these different portions (a training portion and an effectiveness testing portion) may be changed during each cycle of training. This may avoid overtraining the conditional probability distribution 110. Said in other words, this may avoid adapting the conditional probability distribution 110 too much to the training address and maladapting the conditional probability distribution 110 for addresses encountered in normal use or in addresses encountered in “the real world.” This variation of use of training data may be referred to in some contexts as cross-validation of training data.

Because each address token can be characterized and analyzed at the same time in terms of multiple distinct features, the discriminative probabilistic model 108 taught herein may be said to train or learn based on a plurality of features per address token. It may even be said that the discriminative probabilistic model 108 taught herein may train or learn based on an unlimited number of features per address token, given that there is no inherent limit to the addition of new address features to the address features 112 and the use of these additional address features by the semantic address parser 106, the discriminative probabilistic model 108, and/or the conditional probability distribution 110.

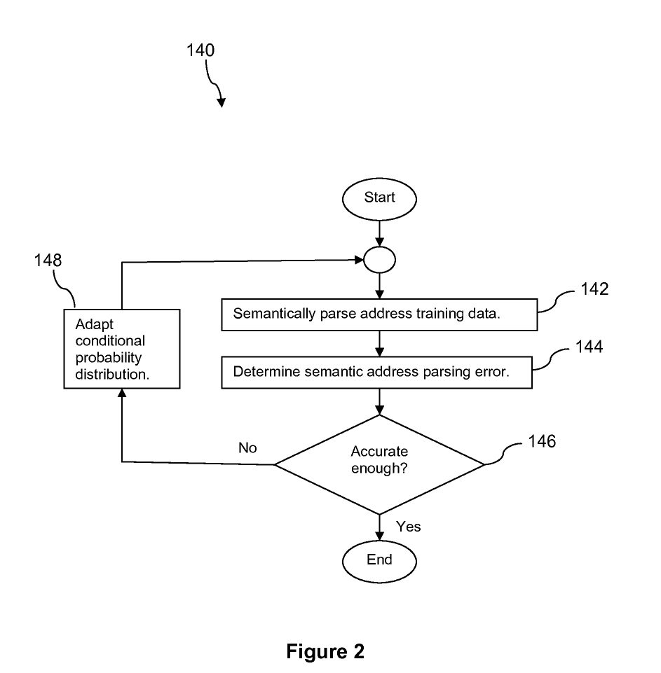

Turning now to FIG. 2, a training method 140 is described. The method 140 provides a visual representation of the process of training the semantic address parser 106, the discriminative probabilistic model 108, and/or the conditional probability distribution 110 that is discussed above. Training entails adapting or adjusting the weights of address features and the weights on combinations of address features in the conditional probability distribution 110 to reduce the error experienced when parsing training data. At block 142, semantically parse address training data. This involves parsing the training addresses into sequences of address tokens, analyzing the address tokens, assigning feature values to the address tokens based on the analysis, and assigning address labels to each address token based on the feature values of the tokens, on the discriminative probabilistic model 108, and on the interim conditional probability distribution 110. For example, the address label for each address token is determined and assigned to that address token so as to maximize the probabilities associated with those assignments considered across all the address tokens of the subject training address. In an embodiment, the semantic address parser 106 may first remove punctuation marks such as commas and periods from the training or input addresses before performing the processing of block 142. The term “interim conditional probability distribution” is used merely to indicate that the values of the weights of features in the conditional probability distribution are expected to change during the training mode of operation of the semantic address parser 106 and/or the discriminative probabilistic model 108.

At block 144, the semantic address parsing error is determined by comparing the assigned address labels for each address token with the human adjudicated address label assignments for each address token. At block 146, the error is evaluated to determine if the interim conditional probability distribution 110 provides a sufficiently accurate semantic address parsing result. If the results are accurate enough, the processing ends and the conditional probability distribution 110 is finalized or fixed.

If the results are not accurate enough, the processing proceeds to block 148. At block 148, the interim conditional probability distribution 110 is adapted in an attempt to reduce the errors in the semantic address parsing. In an embodiment, the adapting may be performed based on a quasi-Newton algorithm, for example based on a limited memory Broyden-Fletcher-Goldfarb-Shanno (LBFGS) algorithm. After block 148, the processing resumes at block 142, thereby reiterating the training process. In an embodiment, the loop 142, 144, 146, 148 may repeat until the semantic address parsing error is below a predefined threshold. Alternatively, in an embodiment, the loop 142, 144, 146, 148 may be exited if the number of training cycles exceeds a predefined number.

If the desired maximum semantic address parsing error cannot be achieved, the address features 112 may be adjusted to improve the performance of the semantic address parser 106 and/or the discriminative probabilistic model 108. Adjusting the address features 112 may entail adjusting the definition of the address features and the associated software that evaluates the address tokens. Adjusting the address features 112 may include creating new address features, possibly based on reflecting on a class of address parsing error that is observed. Adjusting the address features 112 may also include discarding address features that are ineffective. The creating and adjusting of the address features 112 may be referred to collectively as feature engineering.

Turning now to FIG. 3, a system 200 is described. In an embodiment, the system 200 comprises a computer system 202 and a patient medical record application 204. The application 204 comprises a semantic address parser 206, a discriminative probabilistic model 208, a conditional probability distribution 210, and a plurality of address features 212. The application 204 may also comprise an address canonicalizer 214, an address matcher 216, and a medical record combiner 218. The system 200 further comprises a local data store 222 comprising medical records, a network 220, and a plurality of work stations 224. The system 200 may optionally further comprise one or more remote data stores 226 comprising medical records.

In an embodiment, the semantic address parser 206, the discriminative probabilistic model 208, the conditional probability distribution 210, and the address features 212 may be substantially similar to corresponding elements of FIG. 1, namely the semantic address parser 106, the discriminative probabilistic model 108, the conditional probability distribution 110, and the address features 112. The semantic address parser 206 and/or the discriminative probabilistic model 208 may be different in that they may not comprise components that are operable for performing machine learning or training. For example, in an embodiment, the semantic address parser 206 and/or the discriminative probabilistic model 208 may be built omitting training components and/or software. Alternatively, the semantic address parser 206 and/or the discriminative probabilistic model 208 may comprise training components or software, but they may be disabled or prevented from executing in a deployed state. This may reflect the decision that training and adaptation of the semantic address parser 206, the discriminative probabilistic model 208, and/or the conditional probability distribution 210 be performed in an engineering development environment and/or in an environment conducive to rigorous software configuration control.

The network 220 comprises one or more private networks, one or more public networks, or a combination thereof. The work stations 224 may be computers, for example desktop computers, laptop computers, notebook computers, tablet computers, mobile communication devices, personal digital assistants (PDAs), wearable computers, or the like. The work stations 224 may be employed by various employees of a health service organization such as a hospital, doctor's office, clinic, or other medical service site. The employees may be admissions clerks, nurses, medical technicians, doctors, or others. The remote data stores 226 may comprise a data store of medical records maintained by a state or a federal agency. In some contexts, this may be referred to as a centralized data base of medical records.

In an embodiment, an employee of a health service provider (e.g., a hospital, a doctor's office, a clinic, etc.) interacts with the data store 222 to create a new medical record or to search for a medical record associated with a medical patient. For example, an emergency room admissions clerk may enter information about an emergency room patient into the work station 224. The work station 224 may call one or more functions of the patient medical record application 204 to determine if any stored medical records associated with the emergency room patient can be found in either the local data store 222 or in the remote data store 226. The admissions clerk enters in information about the patient, for example an address of the patient. Due to the situation the clerk may be hurried or misunderstand address information. Additionally, the clerk may mistype or misspell address information. Such an address entry process may be said to be an inherently noisy information process in that the syntactical representation of the semantics of the address may vary significantly from one entry clerk to another and even the same entry clerk may enter the address information differently at different times.

The patient input address is passed by the patient medical record application 204 to the semantic address parser 206. The semantic address parser 206 processes the input address to parse into address tokens and to assign address labels to each address token. The semantic address parser 206 relies on the discriminative probabilistic model 208, the conditional probability distribution 210, and the address features 212 to assign address labels to address tokens, as described further above. Specifically, the semantic address parser 206 identifies feature values of address features 212 that apply to the address tokens, the discriminative probability model 208 processes the features values associated to the address tokens and determines address labels associated to the address tokens based on the discriminative probabilistic model 208 and the conditional probabilistic model 210. The patient medical record application 204 then invokes the address canonicalizer 214 to place the address tokens into canonical form based on the address labels assigned to each address token.

The patient medical record application 204 then invokes the address matcher 216 to search for any medical records having an address that matches the input address (now in a canonical address form) in the local data store 222 and/or the remote data store 226. In an embodiment, the address matcher 216 employs a blocking strategy to reduce the number of medical records that are examined for a matching address. For example, demographic information of the patient such as sex, general age, race, body type may be used to exclude a relatively large proportion of the medical records stored in the local data store 222 and/or the remote data store 226. For example, the blocking strategy may eliminate 90% of all the medical records, thereby speeding the search for medical records having matching addresses.

In an embodiment, the address comparison performed by the address matcher 216 may use a variety of matching algorithms. In an embodiment, the address comparison may rely on an algorithm that measures an edit distance between the patient address, considered as a single string, and the address in the stored medical records, also considered as a single string. Alternatively, the comparison by the address matcher 216 may match corresponding tokens of the patient address (in canonical format) to tokens of the address in the stored medical records, determine an edit distance for each corresponding token, and develop a match score as a sum of weighted factors. This approach may allow reducing the importance of the omission of optional address tokens (for example reducing the importance of the difference between “West Main Street” and “West Main”).

The address matcher 216 may present one or more match candidates on the work station 224 for examination by the admissions clerk, for example in a ranked order from nearest match to lesser match. If the admissions clerk deems that one or more medical records are related to the patient, the medical records may be examined to determine if any allergies to medications are indicated, any procedures have been performed on the patient, or other information. The admissions clerk may indicate on the admissions log or papers any medication allergies that the admitted patient has. The admissions clerk may indicate any recently performed medical procedures, whereby unnecessary duplicate procedures—for example performing chest X-rays or providing vaccination boosters—may be avoided. Said in other words, the clerk can use the identified matching medical record to identify an allergy of a patient to a medication and take steps (e.g., document on an admissions sheet, tag, or bracelet) to avoid the patient being administered that medication. The clerk can use the identified matching medical record to identify a medical procedure that has been performed and take steps (e.g., document or call to attention of other staff) to avoid duplication of the medical procedure unnecessarily.

The admissions clerk may further consolidate medical records so that the medical records of the same patient are easily accessed and associated to the same patient. This may promote improved data for use in medical studies. Consolidated medical records may make processing of medical bills by health insurance providers simpler and ease the burden on patients of working with health insurance providers to settle bills. The admissions clerk or other personnel may use the medical record combiner 218 to consolidate, combine, or link medical records of a common patient. In some cases medical record consolidation and/or linking may be performed at a later time by different personnel.

The above described system 200 may also be used to groom or cleanup medical records to promote more accurate medical studies. For example, medical studies may search data stores 222 and/or 226 for medical records related to specific medical conditions. If these studies erroneously disassociate medical records associated with the same patient (for example, when the system 200 is NOT employed to groom the medical records first), the results of the studies may be compromised and/or reduced in quality. The system 200 may expedite or promote accurate billing of healthcare procedures to health insurance providers. Again, it is emphasized that the matching of addresses promoted by the system 200 is simply infeasible for human beings to perform. This is a problem that is amenable only to an automated and/or computer solution.

While the semantic address parser 106, 206 was described above in the use case of matching medical records, it is understood that the teachings of the present disclosure can be used advantageously to implement different address parsers for different use cases. For example, the semantic address parser can be used to thwart credit card fraud and to thwart money laundering. The semantic address parser can identify and/or separate city, zip code, and state information in an address of a wire transmission application, and determine if the address matches a county that has been identified as associated with an abnormal volume of credit card fraud. This then can be used to apply higher authorization requirements on a credit card payment transaction.

Money laundering may entail dividing money between multiple electronic channels and moving the money through multiple electronic channels via multiple hops to a final deposit account, in an attempt to obfuscate the trail of the money and make it difficult for law enforcement to follow. The address parsing tools taught by the present disclosure can be used in association with money laundering analysis, for example to track and identify patterns of money transfers associated with money laundering activities.

Some large corporations support what is referred to as a positive pay system to reduce the incidence of paycheck modification. Under such a positive pay system, the corporation notifies one or more banks in advance of issuing pay checks along with the names of employees on the checks and the amounts of the checks to each employee. The bank, when cashing the pay check, can verify that the pay amount matches the name. A bank or other check cashing business may scan a paycheck using optical character recognition and provide an un-segmented string of characters to the semantic address parser 206. The semantic address parser 206 can be used to parse addresses into a recipient address label and a non-recipient address label. The bank or other check cashing business can then use the recipient address label to index into a list of paychecks and determine the authorized pay amount. If the pay amount on the check differs from the authorized pay amount indexed by the recipient address label, a bank teller may investigate.

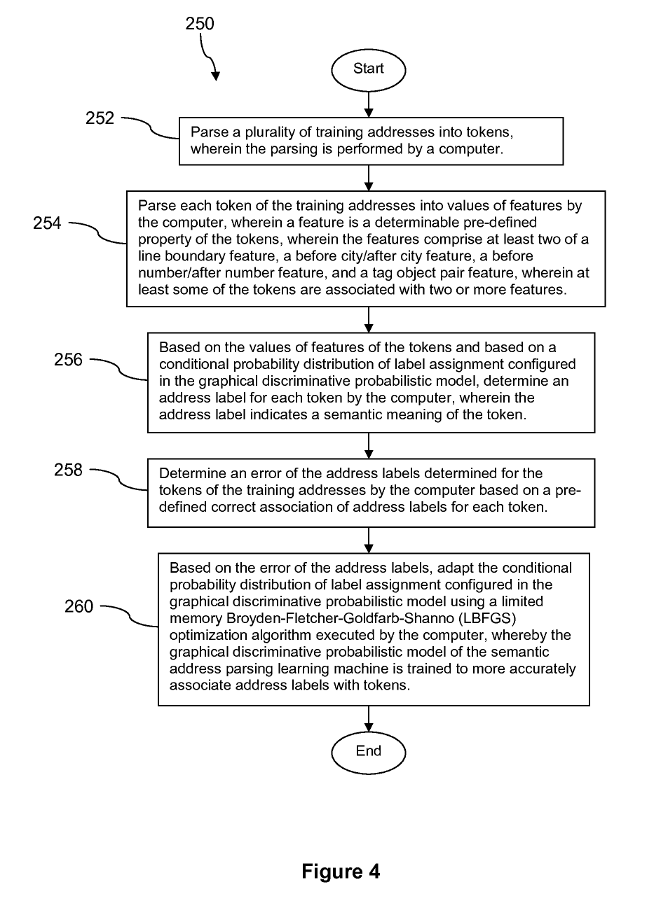

Turning now to FIG. 4, a method 250 is described. At block 252, parse a plurality of training addresses into tokens, wherein the parsing is performed by a computer. The semantic address parser 106 may first remove punctuation marks such as commas and periods from the training or input addresses before performing the processing of block 252. At block 254, parse each token of the training addresses into values of features by the computer, wherein a feature is a determinable pre-defined property of the tokens, wherein the features comprise at least two of a line boundary feature, a before city/after city feature, a before number/after number feature, and a tag object pair feature, wherein at least some of the tokens are associated with two or more features.

At block 256, based on the values of features of the tokens and based on a conditional probability distribution of label assignment configured in the graphical discriminative probabilistic model, determine an address label for each token by the computer, wherein the address label indicates a semantic meaning of the token. At block 258, determine an error of the address labels determined for the tokens of the training addresses by the computer based on a pre-defined correct association of address labels for each token. The pre-defined correct association of address labels may be referred to as human adjudicated address labels. At block 260, based on the error of the address labels, adapt the conditional probability distribution of label assignment configured in the graphical discriminative probabilistic model using an optimization algorithm, whereby the graphical discriminative probabilistic model of the semantic address parsing learning machine is trained to more accurately associate address labels with tokens. In an embodiment, the processing of block 260 may use a quasi-Newtonian algorithm to optimize. In an embodiment, the processing of block 260 may use a limited memory Broyden-Fletcher-Goldfarb-Shanno (LBFGS) (an instance of a quasi-Newtonian algorithm) optimization algorithm executed by the computer. Alternatively some other optimization algorithm may be used.

In an embodiment, the processing of blocks 252 through 260 are iterated multiple times to converge on a trained conditional probability distribution 110. As described above, a portion of the training data 114 may be used to drive the training of blocks 252 through 260 and a different portion of the training data 114 may be used to test the accuracy of the in-progress conditional probability distribution 110. If the training does not achieve the desired accuracy, the features that are used may be adapted, which can be referred to as feature engineering. Feature engineering can refer to both the initial creation of features and the adaptation of features during training, for example discarding of ineffective features, adapting existing features, and creating new features. In an embodiment, cross-validation of training data may be employed, as described above with reference to FIG. 1.

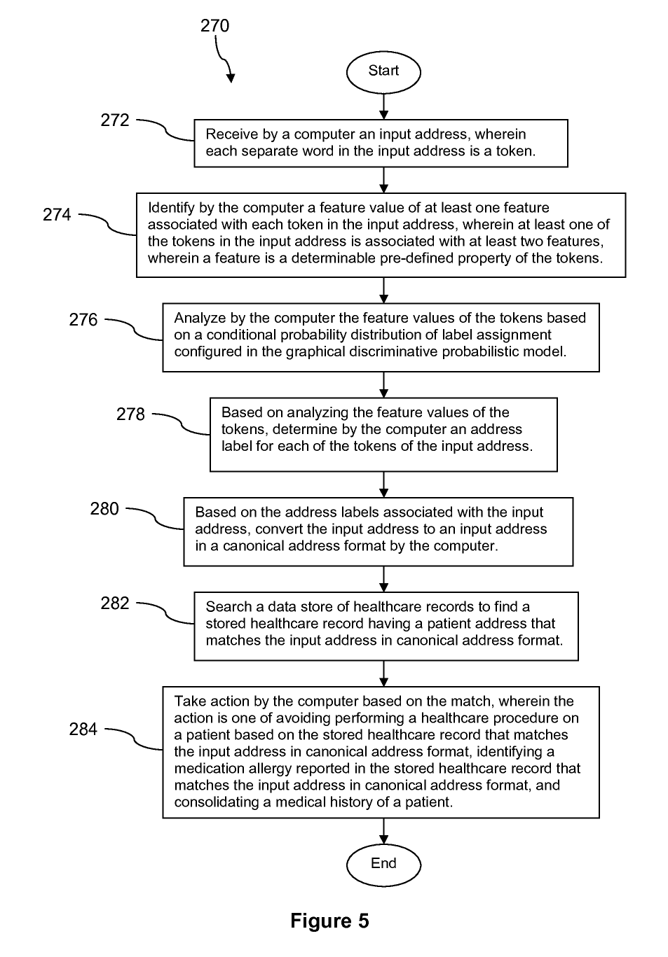

Turning now to FIG. 5, a method 270 is described. At block 272, receive by a computer an input address, wherein each separate word in the input address is a token. At block 274, identify by the computer a feature value of at least one feature associated with each token in the input address, wherein at least one of the tokens in the input address is associated with at least two features, wherein a feature is a determinable pre-defined property of the tokens. In an embodiment, punctuation marks such as commas and periods are removed from the input addresses before performing the processing of block 274. At block 276, analyze by the computer the feature values of the tokens based on a conditional probability distribution of label assignment configured in the graphical discriminative probabilistic model.

At block 278, based on analyzing the feature values of the tokens, determine by the computer an address label for each of the tokens of the input address. At block 280, based on the address labels associated with the input address, convert the input address to an input address in a canonical address format by the computer.

At block 282, search a data store of medical records to find a stored medical record having a patient address that matches the input address in canonical address format. At block 284, take action by the computer based on the match, wherein the action is one of avoiding performing a healthcare procedure on a patient based on the stored medical record that matches the input address in canonical address format, identifying a medication allergy reported in the stored medical record that matches the input address in canonical address format, and consolidating a medical history of a patient.

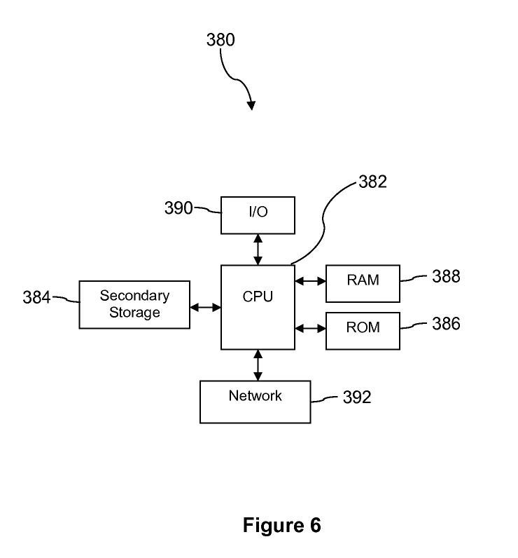

FIG. 6 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer system for managing medical records based on semantic address parsing, comprising:
a processor;
a memory; and
an application that comprises a semantic address parser that incorporates a graphical discriminative probabilistic model and that is stored in the memory that, when executed by the processor
receives a patient address as input, wherein each separate word in the patient address is a token,
for each token identifies a feature value of at least one feature associated with the token, wherein a feature is a determinable pre-defined property of the tokens and wherein at least one of the tokens is associated with two or more features,
analyzes the feature values of the features associated with the tokens to determine an address label for each token, wherein the address labels indicate a semantic meaning of the tokens,
based on the address labels of the tokens, converts the input patient address to an input address in canonical address format,
searches a data store of medical records to find a stored medical record having a patient address that matches the input address in canonical address format, and
processes a medical record associated with the input patient address based on the matching stored medical record.

2. The computer system of claim 1, wherein the address labels comprise a recipient label, a street number label, a pre-direction label, a street label, a designator label, a post-direction label, a city label, a state label, and a zip-code label.

3. The computer system of claim 1, wherein the graphical discriminative probabilistic model is a conditional random field (CRF) probabilistic model.

4. The computer system of claim 1, wherein the application analyzes the tokens of the patient address based on a line boundary feature, a before city/after city feature, a before number/after number feature, and a tag object pair feature.

5. The computer system of claim 1, wherein the application analyzes the tokens of the patient address based on a near “and” feature.

6. The computer system of claim 1, wherein the application analyzes the tokens of the patient address based on multiple basic dictionary tags feature that takes into consideration overlaps of different dictionary tags with a token.

7. The computer system of claim 1, wherein the matching stored medical record is used by a healthcare provider to identify an allergy to a medication or to avoid duplication of a medical procedure.

8. A method of training a semantic address parsing learning machine having a graphical discriminative probabilistic model, comprising:
parsing a plurality of training addresses into tokens, wherein the parsing is performed by a computer;
parsing each token of the training addresses into values of features by the computer, wherein a feature is a determinable pre-defined property of the tokens, wherein the features comprise at least two of a line boundary feature, a before city/after city feature, a before number/after number feature, and a tag object pair feature, wherein at least some of the tokens are associated with two or more features;
based on the values of features of the tokens and based on a conditional probability distribution of label assignment configured in the graphical discriminative probabilistic model, determining an address label for each token by the computer, wherein the address label indicates a semantic meaning of the token;
determining an error of the address labels determined for the tokens of the training addresses by the computer based on a pre-defined correct association of address labels for each token; and
based on the error of the address labels, adapting the conditional probability distribution of label assignment configured in the graphical discriminative probabilistic model using a quasi-Newton optimization algorithm executed by the computer, whereby the graphical discriminative probabilistic model of the semantic address parsing learning machine is trained to more accurately associate address labels with tokens.

9. The method of claim 8, wherein the parsing of the training addresses into tokens, parsing the tokens of the training addresses into values of features, determining an address label for each token, determining an error of the address labels, and adapting the conditional probability distribution of label assignment configured in the graphical probabilistic model is iterated a plurality of times.

10. The method of claim 9, wherein a portion of training addresses are used to train the graphical discriminative probabilistic model and a remaining portion of training addresses are used to cross-validate the training of the graphical discriminative probabilistic model.

11. The method of claim 8, wherein the graphical discriminative probabilistic model is a conditional random field (CRF) probabilistic model.

12. The method of claim 11, wherein the conditional random field probabilistic model processes feature values of tokens.

13. The method of claim 8, wherein the features further comprise a neighbor features feature that identifies the feature values associated with the previous token and the feature values associated with the two subsequent tokens for the subject token.

14. The method of claim 8, wherein the quasi-Newton optimization algorithm is a limited memory Broyden-Fletcher-Goldfarb-Shanno (LBFGS) optimization algorithm.

15. A method of managing medical records using a semantic address parser having a graphical discriminative probabilistic model, comprising:
receiving by a computer an input address, wherein each separate word in the input address is a token;
identifying by the computer a feature value of at least one feature associated with each token in the input address, wherein at least one of the tokens in the input address is associated with at least two features, wherein a feature is a determinable pre-defined property of the tokens;
analyzing by the computer the feature values of the tokens based on a conditional probability distribution of label assignment configured in the graphical discriminative probabilistic model;
based on analyzing the feature values of the tokens, determining by the computer an address label for each of the tokens of the input address;
based on the address labels associated with the input address, converting the input address to an input address in a canonical address format by the computer;
searching a data store of medical records to find a stored medical record having a patient address that matches the input address in canonical address format; and
taking action by the computer based on the match, wherein the action is one of avoiding performing a healthcare procedure on a patient based on the stored medical record that matches the input address in canonical address format, identifying a medication allergy reported in the stored medical record that matches the input address in canonical address format, and consolidating a medical history of a patient.

16. The method of claim 15, further comprising removing punctuation marks from the input address before identifying feature values of tokens of the input address.

17. The method of claim 15, wherein the canonical address format identifies a unique spelling for directions and a unique spelling for street designations.

18. The method of claim 15, further comprising removing line breaks within the input address before identifying feature values of tokens of the input address.

19. The method of claim 15, wherein the features identified for the tokens comprise an after number/before number feature, a before city/after city feature, and a near “and” feature.

20. The method of claim 15, wherein the features identified for the tokens comprise a neighbor features feature, that identifies the feature values associated with the previous token and the feature values associated with the two subsequent tokens for the subject token.
